(19) United States
(12) Patent Application Publication
(10) Pub. No.: US 2022/0347816 A1
(43) Pub. Date: Nov. 3, 2022

(54) Polishing Article, Polishing System and Method of Polishing

(71) Applicant: 3M INNOVATIVE PROPERTIES COMPANY, St. Paul, MN (US)

(72) Inventors: Lian S. Tan, Woodbury, MN (US); James P. Burke, Saint Paul, MN (US); Justin W. Lerbakken, Minneapolis, MN (US)

(21) Appl. No.: 17/773,923

(22) PCT Filed: Oct. 29, 2020
(86) PCT No.: PCT/IB2020/060152

§ 371 Date: May 3, 2022

Related U.S. Application Data
(60) Provisional application No. 62/930,035, filed on Nov. 4, 2019.

(51) Int. Cl. B24B 37/26; B24B 37/04; B32B 7/12; B32B 3/12

(52) U.S. Cl. CPC B24B 37/26; B24B 37/042; B32B 7/12; B32B 3/12; B32B 2475/00; B32B 2307/748

(57) ABSTRACT

A polishing article includes a polishing layer having a working surface including at least one multi-cell structure disposed on the working surface. The multi-cell structure includes three cells, defined as a first cell, a second cell and a third cell. Each of the three cells includes at least one sidewall defining a cell shape. The first cell and the second cell include a first common sidewall including a first channel, having a first channel length, allowing fluid communication between the first cell and the second cell, and a first axis perpendicular to the first channel length and substantially parallel to the working surface. Further, the second cell and the third cell include a second common sidewall including a second channel, having a second channel length, allowing fluid communication between the second cell and the third cell, and a second axis perpendicular to the second channel length and substantially parallel to the working surface. An included angle between the first axis and the second axis is from 0° to less than 180°.

### TECHNICAL FIELD

The present disclosure relates to polishing articles, polishing systems and methods of polishing.

### BACKGROUND

Lapping and polishing are important finishing processes in many different industries, including optical component fabrication and semiconductor wafer production. These finishing processes can, generally, be classified into two basic categories: fixed abrasive polishing/lapping and slurry polishing/lapping.

Fixed abrasive, as its name implies, employs abrasive elements that are incorporated or bonded into or onto a polishing/lapping article (surface, pad, etc.; hereinafter referred to as polishing article). The fixed abrasive polishing article is rotated and the substrates to be lapped/polished are pressed against the fixed abrasive polishing article's surface to achieve the desired result.

Slurry polishing/lapping is also a common process for smoothing the topography of a surface. Performed in either a single-sided or double-sided operation, a polishing article is rotated and a substrate is pressed against a surface of the polishing article while an abrasive slurry is added to the contact surface between the polishing article and the substrate. The abrasive slurry contacts both the article and the substrate, and removes material from the substrate.

During either polishing or lapping operations, there is a possibility of stiction between the substrate and the polishing article. In some cases, the stiction may be high enough to cause breakage of the substrate during the finishing operation.

### SUMMARY

The present disclosure may comprise one or more of the following features and combinations thereof.

The present disclosure is generally directed to polishing articles with improved structural aspects having less stiction while maintaining high removal rates. The polishing articles of the present disclosure may have utility in both polishing and lapping applications.

In a first aspect, there is provided a polishing article including a polishing layer having a working surface including at least one multi-cell structure disposed on the working surface. The at least one multi-cell structure includes three cells, defined as a first cell, a second cell and a third cell. Each of the three cells includes at least one sidewall defining a cell shape. The first cell and the second cell include a first common sidewall. The first common sidewall includes a first channel, having a first channel length, allowing fluid communication between the first cell and the second cell, and a first axis perpendicular to the first channel length and substantially parallel to the working surface. Further, the second cell and the third cell include a second common sidewall. The second common sidewall includes a second channel, having a second channel length, allowing fluid communication between the second cell and the third cell, and a second axis perpendicular to the second channel length and substantially parallel to the working surface. An included angle between the first axis and the second axis is from 0 degree)(°) to less than 180°.

In one embodiment, the included angle is greater than 20° and no greater than 160°.

In one embodiment, the included angle is greater than 45° and no greater than 135°.

In one embodiment, the at least one multi-cell structure is a plurality of multi-cell structures.

In some embodiments, the plurality of multi-cell structures has a cell density from 0.01 cells per square centimeter (cells/cm²) to 1000000 cells/cm². In some embodiments, the plurality of multi-cell structures has a cell density from 0.1 cells/cm² to 100000 cells/cm². In some embodiments, the plurality of multi-cell structures has a cell density from 1 cell/cm² to 10000 cells/cm². In some embodiments, the plurality of multi-cell structures has a cell density from 1 cell/cm² to 1000 cells/cm². In some embodiments, the plurality of multi-cell structures has a cell density from 1 cell/cm² to 100 cells/cm².

In one embodiment, the plurality of multi-cell structures is distributed randomly. In another embodiment, the plurality of multi-cell structures is distributed in a repeating pattern.

In one embodiment, a longest dimension of each of the three cells is between 10 microns and 10 centimeters.

In one embodiment, a longest dimension of each of the three cells is between 10 microns and 1 centimeters.

In one embodiment, a longest dimension of each of the three cells is between 10 microns and 1000 microns.

In one embodiment, the polishing layer is a unitary body.

In one embodiment, the polishing article further includes a backing having a first major surface and an opposed second major surface. The at least one multi-cell structure is disposed on the first major surface of the backing. The at least one sidewall of each of the three cells of the at least one multi-cell structure is in contact with the first major surface of the backing.

In one embodiment, the polishing article further includes an adhesive having opposed first and second major surfaces. The first major surface of the adhesive is disposed on the second major surface of the backing.

In one embodiment, the polishing article further includes a release liner disposed on the second major surface of the adhesive.

In one embodiment, the at least one sidewall of the first cell includes a linking channel spaced apart from the first channel.

In one embodiment, the at least one sidewall of the third cell includes a linking channel spaced apart from the first channel.

In a second aspect, there is provided a polishing system including the polishing article of the first aspect, and a polishing solution disposed on the at least one multi-cell structure of the polishing article.

In a third aspect, there is provided a method of polishing a substrate. The method includes providing a polishing article of the first aspect. The method further includes providing a substrate having a surface to be polished. The method further includes positioning the substrate adjacent to the polishing article. The surface to be polished of the substrate is adjacent to the at least one multi-cell structure of the polishing article. The method further includes applying a force to at least one of the substrates and the polishing article, such that a pressure is applied to the substrate surface to be polished and the at least one multi-cell structure of the polishing article. The method further includes moving at least one of the substrate and polishing article relative to each other.

In one embodiment, the method further includes providing a polishing solution between the surface to be polished of the substrate and the at least one multi-cell structure.

The details of one or more embodiments of the disclosure are set forth in the accompanying drawings and the description below. Other features, objects, and advantages of the invention will be apparent from the description and drawings, and from the claims.

### BRIEF DESCRIPTION OF DRAWINGS

Like symbols in the drawings indicate like elements. Dotted lines indicate optional or functional components, while dashed lines indicate components out of view.

FIG. 1 illustrates a schematic cross-sectional diagram of an exemplary single-sided polishing system for utilizing the polishing articles and methods in accordance with some embodiments discussed herein;

FIG. 2 illustrates a schematic cross-sectional diagram of an exemplary double-sided polishing system for utilizing the polishing articles and methods in accordance with some embodiments discussed herein.

FIG. 3 illustrates a schematic cross-sectional diagram of a polishing article in accordance with some embodiments of the present disclosure.

FIG. 4 illustrates a top view of an exemplary polishing article in accordance with some embodiments discussed herein.

FIG. 5 illustrates a schematic side view of an exemplary profile of the polishing article in accordance with some embodiments discussed herein.

FIG. 6 illustrates a schematic top view of an exemplary multi-cell structure of the polishing article in accordance with some embodiments discussed herein.

FIG. 7 illustrates schematic top views of exemplary cells of the multi-cell structure in accordance with some embodiments discussed herein.

FIG. 8A illustrates a schematic top view of an exemplary multi-cell structure of a polishing article in accordance with some embodiments discussed herein.

FIG. 8B illustrates a schematic top view of an exemplary pattern containing two multi-cell structures of a polishing article in accordance with some embodiments discussed herein.

FIG. 9 illustrates schematic top views of various cell configurations of the multi-cell structure in accordance with some embodiments discussed herein.

FIG. 10 illustrates a schematic perspective view of an exemplary multi-cell structure of the polishing article in accordance with some embodiments discussed herein.

FIG. 11 illustrates a schematic top view of an exemplary multi-cell structure of the polishing article in accordance with some embodiments discussed herein.

FIG. 12 illustrates a schematic top view of an exemplary multi-cell structure of the polishing article in accordance with some embodiments discussed herein.

FIG. 13 illustrates a schematic top view of an exemplary multi-cell structure of the polishing article in accordance with some embodiments discussed herein.

FIG. 14 illustrates a schematic cross-sectional diagram of a polishing article in accordance with some embodiments of the present disclosure.

FIG. 15 illustrates a flow diagram of an exemplary method of polishing a substrate in accordance with some embodiments discussed herein.

FIG. 16 illustrates a schematic perspective view of the cell pattern of the polishing article of Comparative Example 2.

### DETAILED DESCRIPTION

A polishing/lapping process removes material from a substrate by contacting a surface of the substrate against a surface of a polishing article, i.e. the working surface of the polishing article. Often, a polishing solution, e.g. a slurry, is disposed between the substrate surface and polishing article to facilitate the material removal process. A conventional polishing article includes a microstructure on its polishing surface to enhance polishing/lapping by the polishing solution. A conventional microstructure includes a closed cell configuration that generally results in high levels of stiction between the polishing article and the substrate. Stiction, which is associated with high frictional forces (and which also may be related to surface tension and pressure effects), between the substrate surface and the adjacent article surface, may result in non-uniform polishing and/or increased defects in the substrate surface. In some cases, the stiction may be high enough to cause breakage of the substrate during polishing.

The present disclosure provides a polishing article (e.g., pad) including a polishing layer having a working surface that includes at least one multi-cell structure. The at least one multi-cell structure includes cells that are interconnected with each other. Interconnection between the cells may reduce stiction between the polishing article and a substrate that is being polished. The polishing article of the present disclosure may maintain high removal rate while significantly reducing stiction, thereby enabling stable processing of the substrate.

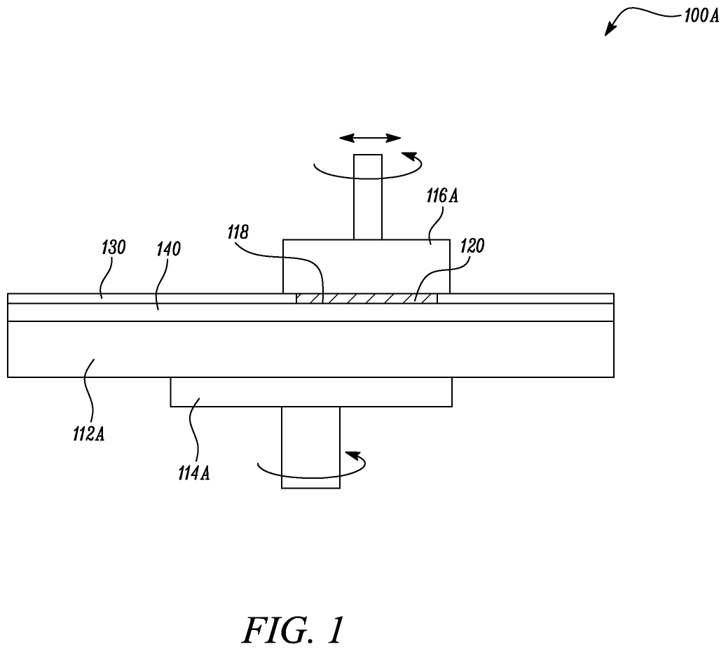

FIG. 1 illustrates a schematic cross-sectional diagram of an exemplary polishing system 100A for utilizing the polishing articles and methods in accordance with some embodiments of the present disclosure. Polishing system 100A may include a platen 112A, a drive assembly 114A, a polishing head assembly 116A, a substrate 120, a polishing solution 130, and a polishing article 140. The shape of the polishing article is not particularly limited. In some embodiments, the shape of the polishing article is circular. Polishing solution 130 may be disposed between a major surface of substrate 120 and the adjacent major surface of polishing article 140. Further, polishing solution 130 may be a polishing slurry. Platen 112A may be configured to house and/or secure polishing article 140. Drive assembly 114A may be coupled to platen 112A and configured to rotate platen 112A and, correspondingly, polishing article 140. Polishing head assembly 116A may be coupled to substrate 120 and configured to rotate substrate 120, move substrate 120 across a plane of polishing article 140, and apply a force to substrate 120 to urge substrate 120 against polishing article 140 at a polishing surface 118 of substrate 120. Polishing solution 130 and polishing article 140, in combination, may remove material of substrate 120 at polishing surface 118. The exemplary polishing system may be referred to as a rotary, single-sided polishing system, as the polishing article is typically rotated about an axis by the platen and only one polishing article is present that engages with one major surface (single-side) of the substrate

While a rotary, single-sided polishing system has been described above, other polishing systems may be used. For example, a polishing article may be a polishing belt linearly fed or driven along a single dimension, rather than rotationally driven. As another example, more than one polishing article may contact a substrate, as in a double-sided polisher. Other example systems include, but are not limited to, belt polishers, oscillating polishers, double-sided polishers, and the like.

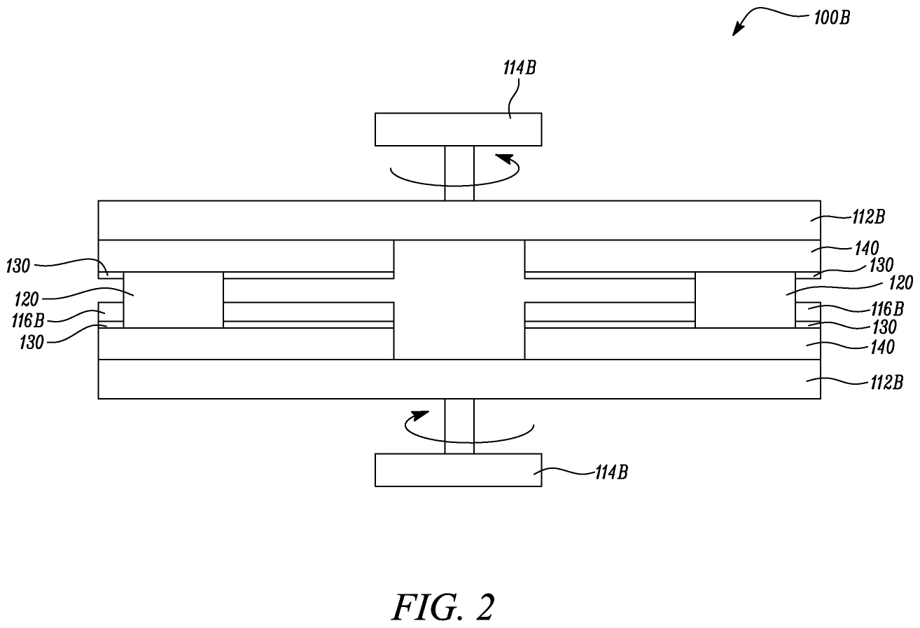

FIG. 2 is a schematic cross-sectional diagram of an exemplary double-sided polishing system 100B for utilizing the polishing articles and methods in accordance with some embodiments of the present disclosure. Polishing system 100B may include two platens 112B, two drive assemblies 114B, one or more carriers 116B, substrates 120, a polishing solution 130, and two polishing articles 140. Platen 112B may be configured to house and/or secure polishing article 140. Polishing article 140 may be annular in shape. Platens 112B may be configured to apply a force to substrate 120. Drive assembly 114B may be coupled to platen 112B and configured to rotate platen 112B and, correspondingly, polishing article 140. Carrier(s) 116B are configured to hold and/or rotate substrates 120 and move substrate 120 across a plane of polishing article 140. Carriers 116B may be configured to rotate by a sprocket-pin mechanism (not shown) located between the platens and at the center and along the circumference of the of the platens. The polishing solution may be disposed between a major surface of substrate 120 and the adjacent major surface of polishing article 140. The polishing solution and polishing article 140, alone or in combination, may remove material of substrate 120 at the polishing surface.

The present disclosure further relates to methods of polishing substrates. The methods may be carried out using a polishing system such as that described with respect to FIGS. 1 and 2, or with any other conventional polishing system, e.g., single or double-sided polishing and lapping. In some embodiments, a method of polishing substrate may include providing a substrate to be polished. The substrate may be any substrate for which material removal, e.g. polishing or lapping, and/or planarization is desirable. For example, the substrate and/or the substrate surface may be a metal, metal alloy, metal oxide, ceramic, or polymer (commonly in the form of a semiconductor wafer or optical lens). In some embodiments, the methods of the present disclosure may be particularly useful for polishing ultrahard substrates, such as sapphire (A, R, or C planes), silicon, silicon carbide, quartz, or silicate glasses. The substrate may have one or more surfaces to be polished or lapped. The substrates may be subject to chemical mechanical polishing/planarization (CMP).

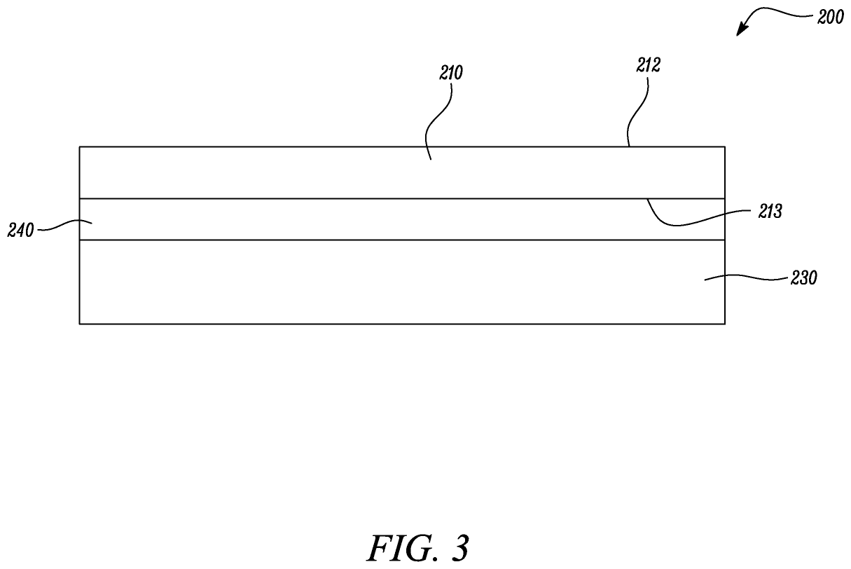

In some embodiments, the polishing article includes a polishing layer having a working surface. The working surface of the polishing layer may be a major surface of the polishing article that is designed to contact the substrate to be polished or lapped. The polishing layer may be in the form of a film that is wound on a core and employed in a “roll to roll” format during use. The polishing layer may also be fabricated into individual pads, e.g., a circular shaped polishing layer of a circular shaped polishing article or an annular shaped polishing layer of an annular shaped polishing article, as further discussed below. According to some embodiments of the present disclosure, the polishing article, which includes a polishing layer, may also include a subpad. FIG. 3 shows a polishing article 200, which includes a polishing layer 210, having a working surface 212 and a second surface 213 opposite working surface 212, and a subpad 230 adjacent to second surface 213. Optionally, a foam layer 240 is interposed between the second surface 213 of polishing layer 210 and subpad 230. The various layers of the polishing article can be adhered together by any techniques known in the art, including using adhesives, e.g., pressure sensitive adhesives (PSAs), hot melt adhesives and cure in place adhesives. In some embodiments, the polishing article includes an adhesive layer adjacent to the second surface. Use of a lamination process in conjunction with PSAs, e.g., PSA transfer tapes, is one particular process for adhering the various layers of polishing article 200. Subpad 230 may be a single layer of a relatively stiff material, e.g., polycarbonate, or a single layer of a relatively compressible material, e.g., an elastomeric foam. Subpad 230 may also have two or more layers and may include a substantially rigid layer (e.g., a stiff material or high modulus material like polycarbonate, polyester and the like) and a substantially compressible layer (e.g., an elastomer or an elastomeric foam material). Foam layer 240 may have a durometer from between about 20 Shore D to about 100 Shore D. Foam layer 240 may have a thickness from between about 125 microns and about 5 mm or even between about 125 microns and about 1000 microns. In some embodiments, one or more layers of subpad 230 may be opaque

In some embodiments of the present disclosure, which include a subpad having one or more opaque layers, a small hole may be cut into the subpad creating a “window”. The hole may be cut through the entire subpad or only through the one or more opaque layers. The cut portion of the subpad or one or more opaque layers is removed from the subpad, allowing light to be transmitted through this region. The hole is pre-positioned to align with the endpoint window of the polishing tool platen and facilitates the use of the wafer endpoint detection system of the polishing tool, by enabling light from the tool's endpoint detection system to travel through the polishing article and contact the wafer. Light based endpoint polishing detection systems are known in the art and can be found, for example, on MIRRA and REFLEXION LK CMP polishing tools available from Applied Materials, Inc., Santa Clara, Calif. Polishing articles of the present disclosure can be fabricated to run on such tools and endpoint detection windows which are configured to function with the polishing tool's endpoint detection system can be included in the article.

In one embodiment, a polishing article including any one of the polishing layers of the present disclosure can, optionally, be laminated to a subpad. The subpad includes at least one stiff layer, e.g., polycarbonate. In some embodiments, the subpad may include a compliant layer, e.g., an elastomeric foam. In other embodiments, the subpad may include at least one stiff layer and at least one compliant layer, e.g., an elastomeric foam, the elastic modulus of the stiff layer being greater than the elastic modulus of the compliant layer. The compliant layer may be opaque and prevent light transmission required for endpoint detection. The stiff layer of the subpad is laminated to the second surface of the polishing layer, typically through the use of a PSA, e.g., transfer adhesive or tape. Prior to or after lamination, a hole may be die cut, for example, by a standard kiss cutting method or cut by hand, in the opaque compliant layer of the subpad. The cut region of the compliant layer is removed creating a “window” in the polishing article. If adhesive residue is present in the hole opening, it can be removed, for example, through the use of an appropriate solvent and/or wiping with a cloth or the like. The “window” in the polishing article is configured such that, when the polishing article is mounted to the polishing tool platen, the window of the polishing article aligns with the endpoint detection window of the polishing tool platen. The dimensions of the hole may be, for example, up to 5 cm wide by 20 cm long. The dimensions of the hole are, generally, the same or similar in dimensions as the dimensions of the endpoint detection window of the platen.

The polishing article thickness is not particularly limited. The polishing article thickness may coincide with the required thickness to enable polishing on the appropriate polishing tool. The polishing article thickness may be greater than about 25 microns, greater than about 50 microns, greater than about 100 microns or even greater than 250 microns; less than about 20 mm, less than about 10 mm, less than about 5 mm or even less than about 2.5 mm. The shape of the polishing article is not particularly limited. The articles may be fabricated such that the article shape coincides with the shape of the corresponding platen of the polishing tool the article will be attached to during use. Article shapes, such as circular, square, hexagonal and the like may be used. A maximum dimension of the article, e.g., the diameter for a circular shaped article, is not particularly limited. The maximum dimension of an article may be greater than about 10 cm, greater than about 20 cm, greater than about 30 cm, greater than about 40 cm, greater than about 50 cm, greater than about 60 cm; less than about 2.5 meter, less than about 2.0 meters, less than about 1.5 meter or even less than about 1.0 meter. As discussed above, the article, including any one of the polishing layers of the present disclosure, an optional subpad, an optional foam layer and any combination thereof, may include a window, i.e., a region allowing light to pass through, to enable standard endpoint detection techniques used in polishing processes, e.g., wafer endpoint detection.

In some embodiments, the polishing layer includes a polymer. Polishing layer 210 may be fabricated from any known polymer, including thermoplastics, thermoplastic elastomers (TPEs), e.g., TPEs based on block copolymers, thermosets, e.g., elastomers, and combinations thereof If an embossing process is being used to fabricate polishing layer 210, thermoplastics and TPEs are generally utilized for polishing layer 210. Thermoplastics and TPEs include, but are not limited to, polyurethanes; polyalkylenes, e.g., polyethylene and polypropylene; polybutadiene, polyisoprene; polyalkylene oxides, e.g., polyethylene oxide; polyesters; polyamides; polycarbonates, polystyrenes, block copolymers of any of the proceeding polymers, and the like, including combinations thereof. In some embodiments, polishing layer 210 may be a curable resin, e.g. UV-curable resin, for example an acrylate and/or methacrylate. In some embodiments, polishing layer 210 may include a polymer blend. In some embodiments, polishing layer 210 may be a polymer/inorganic composite. In some embodiments, the composition of the polishing layer may be at least about 30%, at least about 50%, at least about 70%, at least about 90%, at least about 95%, at least about 99% or even at least about 100% polymer by weight.

In some embodiments, the polishing layer may be porous. In some embodiments, the porosity of the polishing layer may be greater than about 10% by volume, greater than about 25% by volume. or greater than about 40% by volume. The porosity of the polishing layer may be less than about 80% by volume, less than about 70% by volume or less than about 60% by volume.

In some embodiments, the polishing layer may be a unitary body. A unitary body refers to a construction that does not have any internal interfaces, joints, or seams. A unitary body is not formed by bonding components parts together. A unitary body includes only a single layer of material (i.e., it is not a multi-layer construction, e.g., a laminate) and the single layer of material has a single composition. The composition may include multiple-components, e.g. a polymer blend or a polymer-inorganic composite. In some cases, a unitary body is capable of being formed in a single forming step such as casting, embossing or molding. Use of a unitary body as the polishing layer may provide cost benefits, due to minimization of the number of process steps required to form the polishing layer. A polishing layer that includes a unitary body may be fabricated from techniques know in the art, including, but not limited to, molding and embossing.

The hardness and flexibility of polishing layer 210 is predominately controlled by the material(s), e.g. polymer, used to fabricate it. The hardness of polishing layer 210 is not particularly limited. The hardness of polishing layer 210 may be greater than about 20 Shore D, greater than about 30 Shore D or even greater than about 40 Shore D. The hardness of polishing layer 210 may be less than about 100 Shore D, less than about 90 Shore D, less than about 80 Shore D or even less than about 70 Shore D. The hardness of polishing layer 210 may be greater than about 20 Shore A, greater than about 30 Shore A or even greater than about 40 Shore A. The hardness of polishing layer 210 may be less than about 95 Shore A, less than about 80 Shore A or even less than about 70 Shore A. Polishing layer 210 may be flexible. In some embodiments, polishing layer 210 is capable of being bent back upon itself producing a radius of curvature in the bend region of less than about 10 cm, less than about 5 cm, less than about 3 cm, or even less than about 1 cm; and greater than about 0.1 mm, greater than about 0.5 mm or even greater than about 1 mm. In some embodiments, polishing layer 210 is capable of being bent back upon itself producing a radius of curvature in the bend region of between about 10 cm and about 0.1 mm, between about 5 cm and bout 0.5 mm or even between about 3 cm and about 1 mm.

The polymeric materials used to fabricate polishing layer 210 may be used in substantially pure form. The polymeric materials used to fabricate polishing layer 210 may include fillers known in the art. In some embodiments, polishing layer 210 is substantially free of any inorganic abrasive material (e.g. inorganic abrasive particles), i.e., it is an abrasive free polishing article. By substantially free it is meant that polishing layer 210 includes less than about 10% by volume, less than about 5% by volume, less than about 3% by volume, less than about 1% by volume or even less than about 0.5% by volume inorganic abrasive particles. In some embodiments, polishing layer 210 contains substantially no inorganic abrasive particles. An abrasive material may be defined as a material having a Mohs hardness greater than the Mohs hardness of the substrate being abraded or polished. An abrasive material may be defined as having a Mohs hardness greater than about 5.0, greater than about 5.5, greater than about 6.0, greater than about 6.5, greater than about 7.0, greater than about 7.5, greater than about 8.0 or even greater than about 9.0. The maximum Mohs hardness is general accepted to be 10. Polishing layer 210 may be fabricated by any techniques known in the art. Micro-replication techniques are disclosed in U.S. Pat. Nos. 6,285,001; 6,372,323; 5,152,917; 5,435,816; 6,852,766; 7,091,255 and U.S. Pat. Application Publication No. 2010/0188751, all of which are incorporated by reference in their entirety.

In some embodiments, the polishing layer may include abrasive particles. In some embodiments, the amount of abrasive particles in the polishing layer may be greater than 5%, greater than 10%, greater than 20%, greater than 25%; less than 80%, less than 70% less than 65%, less than 60%, less than 55% or even less than 50%, by volume. The abrasive particles are not particularly limited. Suitable abrasive particles include, but are not limited to, fused aluminum oxide; heat-treated aluminum oxide; white fused aluminum oxide; ceramic aluminum oxide materials such as those commercially available under the trade designation 3M CERAMIC ABRASIVE GRAIN from 3M Company, St. Paul, Minn.; brown aluminum oxide; blue aluminum oxide; silicon carbide (including green silicon carbide); titanium diboride; boron carbide; tungsten carbide; garnet; titanium carbide; diamond; cubic boron nitride; garnet; fused alumina zirconia; iron oxide; chromia; zirconia; titania; tin oxide; quartz; feldspar; flint; silica, emery; sol-gel-derived abrasive particles (e.g., including shaped and crushed forms); and combinations thereof. The polymer layer may be a polymer/abrasive composite.

In another embodiment, the present disclosure relates to a polishing system. The polishing system includes any one of the polishing articles of the present disclosure and a polishing solution. The polishing articles may include any of the previous disclosed polishing layers. The polishing solutions used are not particularly limited and may be any of those known in the art. The polishing solutions may be aqueous or non-aqueous. An aqueous polishing solution is defined as a polishing solution having a liquid phase (does not include particles, if the polishing solution is a slurry) that is at least 50% by weight water. A non-aqueous solution is defined as a polishing solution having a liquid phase that is less than 50% by weight water. In some embodiments, the polishing solution is a slurry, i.e., a liquid that contains organic or inorganic abrasive particles or combinations thereof. The concentration of organic or inorganic abrasive particles or combination thereof in the polishing solution is not particularly limited. The concentration of organic or inorganic abrasive particles or combinations thereof in the polishing solution may be, greater than about 0.2%, greater than about 0.5%, greater than about 1%, greater than about 2%, greater than about 3%, greater than about 4% or even greater than about 5% by weight; may be less than about 30%, less than about 20% less than about 15% or even less than about 10% by weight. In some embodiments, the polishing solution is substantially free of organic or inorganic abrasive particles. By “substantially free of organic or inorganic abrasive particles” it is meant that the polishing solution contains less than about 0.5%, less than about 0.25%, less than about 0.1% or even less than about 0.05% by weight of organic or inorganic abrasive particles. In one embodiment, the polishing solution may contain no organic or inorganic abrasive particles. The polishing system may include polishing solutions, e.g., slurries, used for silicon oxide CMP, including, but not limited to, shallow trench isolation CMP; polishing solutions, e.g., slurries, used for metal CMP, including, but not limited to, tungsten CMP, copper CMP and aluminum CMP; polishing solutions, e.g., slurries, used for barrier CMP, including but not limited to, tantalum and tantalum nitride CMP and polishing solutions, e.g., slurries, used for polishing hard substrates, such as, sapphire or silicon carbide. The polishing system may further include a substrate to be polished or abraded.

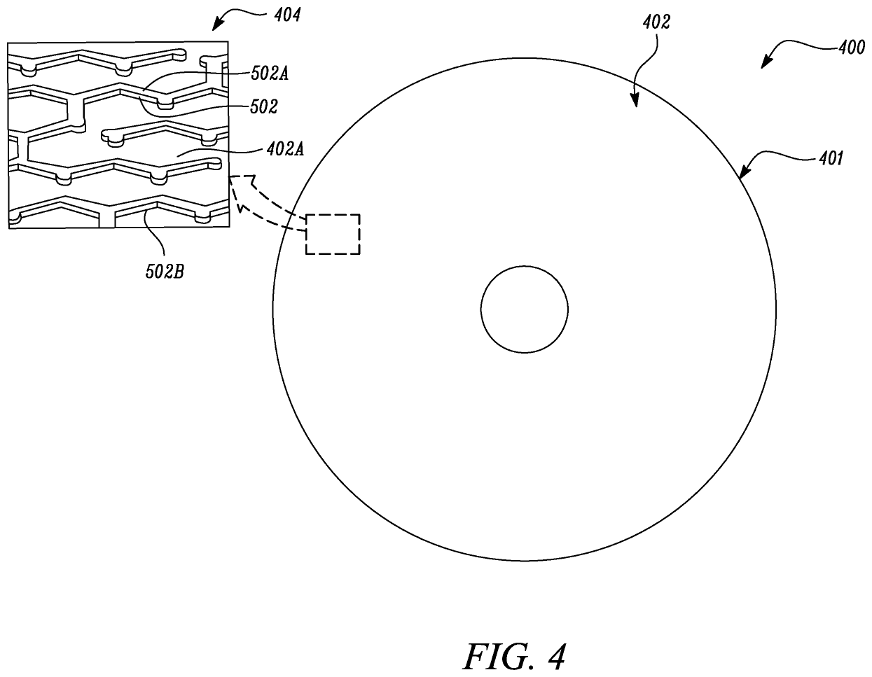

FIG. 4 illustrates a top view of an exemplary polishing article 400. In the illustrated embodiment of FIG. 4, polishing article 400 has an annular shape. However, in alternative embodiments, polishing article 400 may have any other suitable shape, such as circle, polygonal, elliptical, or oval. Polishing article 400 may be a unitary body. Alternatively, polishing article 400 may be made of multiple segments joined to one another. Polishing article 400 includes a polishing layer 401 having a working surface 402. Polishing layer 401 having working surface 402 includes at least one multi-cell structure 404 disposed on working surface 402. Multi-cell structure 404 includes sidewalls 502 having distal ends 502A and a bases 502B. Working surface 402 includes land region 402A (defined by the region between sidewalls 502) and distal ends 502A. Bases 502B of sidewalls 502 are adjacent to and/or intersect land region 402A.

In some embodiments, the at least one multi-cell structure 404 (shown in a detailed view) includes a plurality of multi-cell structures 404. In some embodiments, plurality of multi-cell structures 404 has a cell density from 0.01 cells/cm² to 1000000 cells/cm². In some embodiments, plurality of multi-cell structures 404 has a cell density from 0.1 cells/cm² to 100000 cells/cm². In some embodiments, plurality of multi-cell structures 404 has a cell density from 1 cell/cm² to 10000 cells/cm². In some embodiments, plurality of multi-cell structures 404 has a cell density from 1 cell/cm² to 1000 cells/cm². In some embodiments, plurality of multi-cell structures 404 has a cell density from 1 cell/cm² to 100 cells/cm².

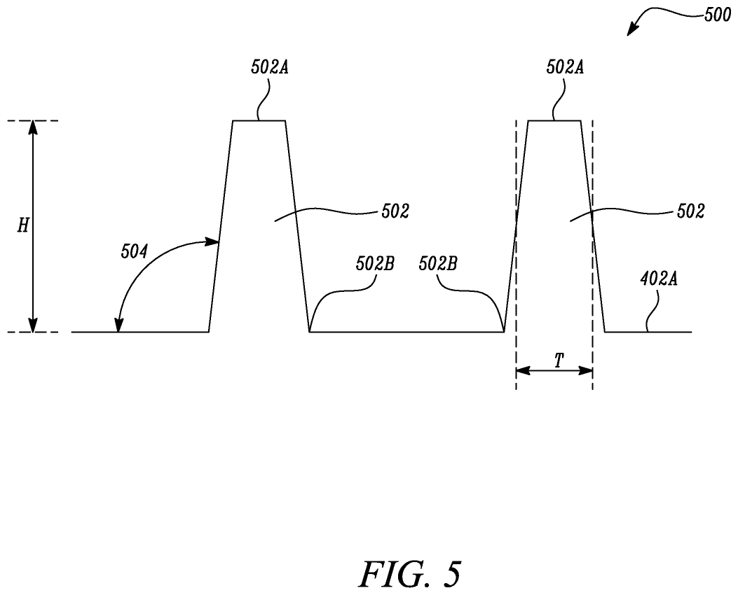

In some embodiments, multi-cell structure 404 is distributed across at least a portion of working surface 402 in a repeating pattern. In some other embodiments, multi-cell structure 404 is distributed across at least a portion of working surface 402 in a random pattern. In some embodiments, combinations of random and repeat patterns of multicell structure 404 may be used, i.e. one or more first region(s) of working surface 402 may include a random pattern and one or more second region(s) of working surface 402 may include a repeating pattern. In some embodiment, multi-cell structure 404 is distributed across at least 30%, at 40% at least 50% at least 60%, at least 70%, at least 80%, at least 85%, at least 90% at least 95%, at least 98% or even 100% of the area of working surface 402. With respect to the above percentages, multi-cell structure 402 is considered to include its corresponding land region. FIG. 5 illustrates an exemplary profile 500 (cross-section of two sidewalls) of multi-cell structure 404 of polishing article 400. Multi-cell structure 404 (shown in FIG. 4) is defined by multiple sidewalls 502 extending from the land region of working surface 402 (shown in FIG. 4) of polishing article 400. Sidewalls 502 have distal ends 502a that define the surface of the sidewall that may contact the substrate being polished. The sum of the total area of the distal ends of sidewalls 502 divided by the total projected area of working surface 402 (e.g. pi times the square of the radius of the polishing article, for a circular polishing article) represents the polishing article's bearing area. This number is often multiplied by 100 to give a percent bearing area. In some embodiments, the percent bearing area of polishing article 400 is greater than 0.5%, greater than 1%, greater than 3%, greater than 5%, greater than 10%, greater than 15%, greater than 20%; less than 90%, less than 80%, less than 70% less than 60%, less than 55%, less than 50% or even less than 45%. In some embodiments, the percent bearing area may range from 0.5% to 90%, 0.5% to 70% or even 0.5% to 50%. Each sidewall 502 may be tapered and defines an exterior angle 504 relative to land region 402A. In some embodiments, exterior angle 504 may be greater than 90 degrees and less than 160 degrees, greater than 90 degrees and less than 140 degrees, greater than 90 degrees and less than 120 degrees or even greater than 90 degrees and less than 110 degrees. Exterior angle 504 may allow a substantially constant bearing area with a substrate as polishing article 400 progressively wears, thereby maintaining a substantially uniform removal rate over a life of polishing article 400. Exterior angle 504 may also help polishing article release from a mold, for example, during manufacture of polishing article 400.

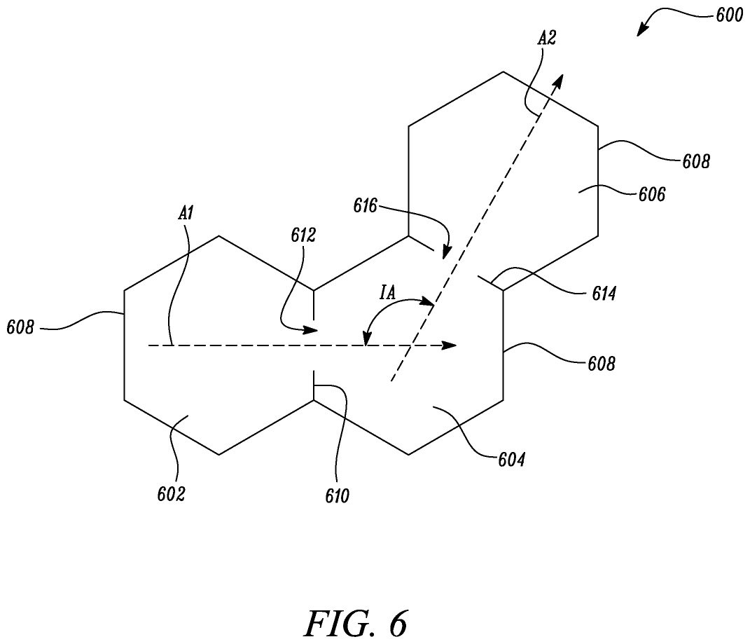

In some embodiments, an average thickness, T, of each sidewall 502 is from about 5 microns to about 10,000 microns, from about 50 microns to about 5,000 microns, from about 200 microns to about 5,000 microns or even from about 400 microns to about 1,000 microns. In some embodiments, an average height, H, of each sidewall 502 is from about 5 microns to about 5000 microns, from about 20 microns to about 5000 microns, from about 60 microns to about 3000 microns or even from about 100 microns to about 2000 microns. The height of the sidewalls of multi-cell structure 404 may be the same, within the tolerances of the manufacturing process used to form them, or may be different. The height of the sidewalls of the plurality of multi-cell structures may be the same within the tolerances of the manufacturing process used to form them, or may be different. FIG. 6 illustrates an exemplary multi-cell structure 600. A polishing layer (e.g. polishing layer 401 of FIG. 4) of a polishing article (e.g., polishing article 400 of FIG. 4) may include at least one multi-cell structure 600. Multi-cell structure 600 includes three cells, defined as a first cell 602, a second cell 604, and a third cell 606. Each of three cells 602, 604, 606 includes at least one sidewall 608 defining a cell shape. The cell shape may act as a reservoir for a polishing solution (i.e. the cell shape is capable of partially enclosing the polishing solution), such as polishing solution 130 shown in FIG. 1. In the present disclosure, an array, e.g. a rectangular grid array, of post like features does not include at least one multi-cell structure. The polishing solution is disposed on at least one multi-cell structure 600 of the polishing article. The reservoir may increase a solution dwell time on a polishing article during polishing. In the illustrated embodiment, each of cells 602, 604, 606 has a hexagonal cell shape. Therefore, each of cells 602, 604, 606 includes six sidewalls 608. However, the cell shape is not particularly limited and in other embodiments, each of cells 602, 604, 606, may have alternative cell shapes. In some embodiments the shape of the cell may be circular, polygonal (e.g. triangular, rectangular, square, pentagonal, hexagonal, octagonal), elliptical, oval, a teardrop shape, an irregular shape or combinations thereof. Further, the cells of a multi-cell structure may have similar or different cell shapes.

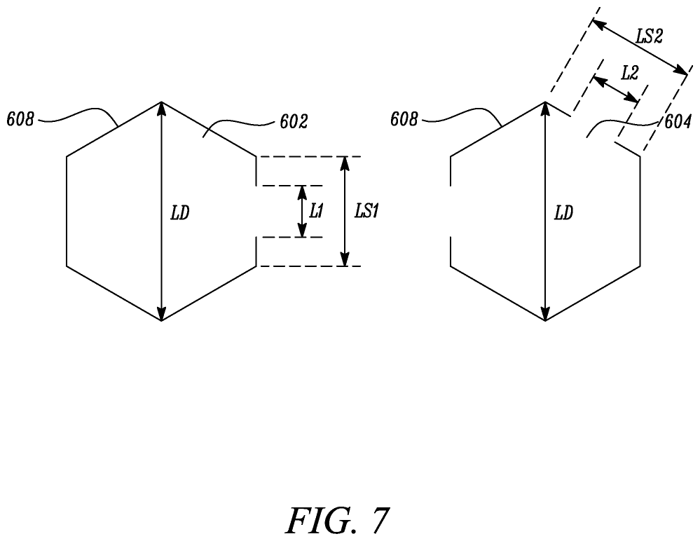

First cell 602 and second cell 604 include a first common sidewall 610. First common sidewall 610 includes a first channel 612. First channel 612 has a first channel length L1 (shown in FIG. 7). First channel 612 allows fluid communication between first cell 602 and second cell 604. First channel 612 further includes a first axis A1 perpendicular to first channel length L1 and substantially parallel to the working surface (e.g. working surface 402 of FIG. 4). Further, second cell 604 and third cell 606 includes a second common sidewall 614. Second common sidewall 614 includes a second channel 616. Second channel 616 has a second channel length L2 (shown in FIG. 7). Second channel 616 allows fluid communication between second cell 604 and third cell 606. Second channel 616 further includes a second axis A2 perpendicular to second channel length L2 and substantially parallel to the working surface. First axis A1 and second axis A2 may form an included angle IA. In some embodiments, included angle IA between first axis A1 and second axis A2 is from 0 degree (°) and less than 180°. In some embodiments, included angle IA is greater than 20° and no greater than 160°. In some embodiments, included angle IA is greater than 45° and no greater than 135°. When determining included angle IA, the first axis A1 and second axis A2 should be considered vectors, selected to point in a direction of fluid communication through the channels. If the vectors of the two axes point in the exact same direction, included angle IA is 180 degrees. If the vectors of the two axes point in the exact opposite direction, included angle IA is zero degrees. In the embodiments of the present disclosure the included angle is defined to be less than about 180 degrees.

Each of cells 602, 604, 606 has a longest dimension LD (shown in FIG. 7) based on the cell shape. In some embodiments, LD may be measured from the midpoint of the distal end of the sidewall. LD is measured substantially parallel to the land region enclosed by the sidewalls of a given cell. In the case of the hexagonal cell shape, longest dimension LD is a distance between two opposing vertices. In some embodiments, longest dimension LD of a cell may be between 10 microns and 10 cm, between 100 microns and 5 cm or even between 500 microns and 1 cm. The longest dimension LD of the three cells of a multi-cell structure may be the same for all three cells or may be different, depending on each individual cell size and shape.

First channel length L1 of first channel 612 may be a fraction of a total length of first common sidewall 610 (length LS1, as shown in FIG. 7). Similarly, second channel length L2 of second channel 616 may be a fraction of a total length of second common sidewall 614 (length LS2, as shown in FIG. 7). For example, first channel length L1 may be about one-third of the total length of first common sidewall 610. Similarly, second channel length L2 of second channel 616 may be about one-third of the total length of second common sidewall 614. In some embodiments, the channel length, e.g. L1 and L2, may be at least 5%, at least 10%, at least 20%, at least 30%, or at least 50% of the total lengths of corresponding common sidewall, e.g. first and second common sidewalls 610 and 614. In some embodiments, the channel length, e.g. L1 and L2, may be less than 90%, less than 80% or even less than 70% of the total length of corresponding common sidewall, e.g. first and second common sidewalls 610 and 614. Although shown a single channel in FIGS. 6 and 7, the channel of a sidewall may include multiple channels. If a sidewall includes multiple channels, the channel length is defined to be the sum of the lengths of the individual channel lengths. In some embodiments, the channel length is measured at the distal end of the sidewall. In sum embodiments, the channel length is measured at the base of the sidewall.

First and second channels 612, 616 enable interconnection, i.e. fluid communication, between first, second and third cells 602, 604, 606 which may allow optimal distribution of the polishing solution. Optimal distribution of the polishing solution may result in uniform polishing of a substrate. Interconnection between first, second and third cells 602, 604, 606 may result in pressure equalization and significantly reduce or eliminate stiction between the polishing article and the substrate. In some embodiments, multi-cell structure 600 may be repeated with some modifications to form a tortuous path for the polishing solution. Such a tortuous path may significantly impede flow of the polishing solution off the polishing article since there is no direct flowpath or channel for the polishing solution to leave the polishing article.

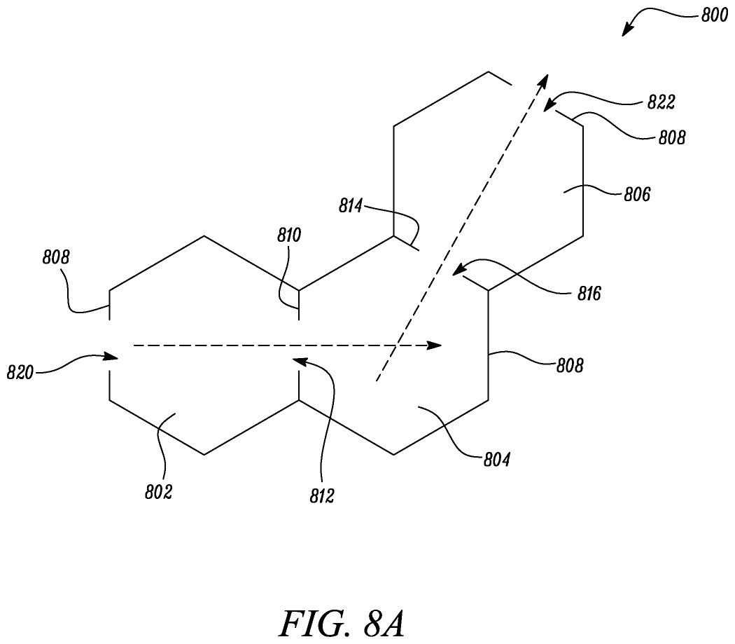

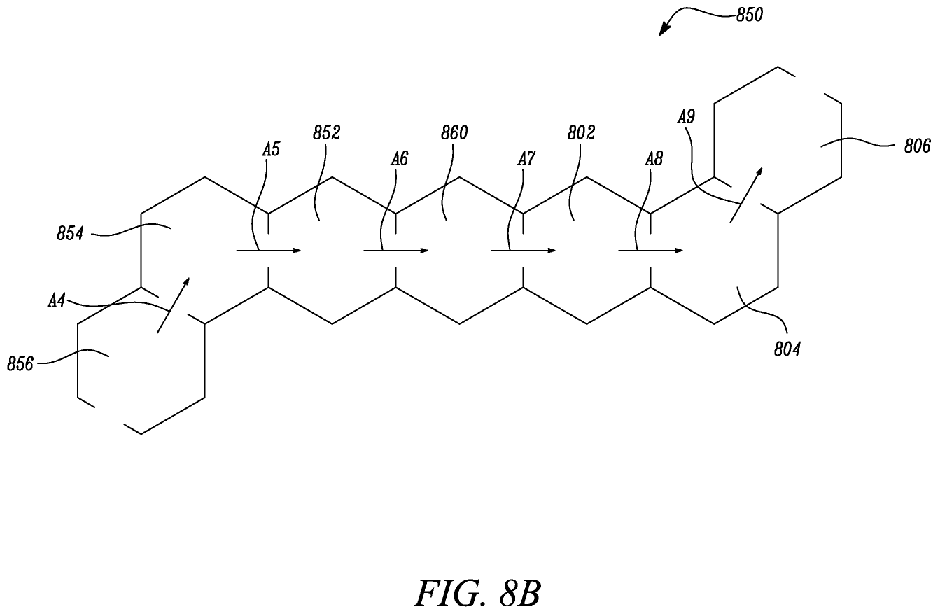

FIG. 8A illustrates an exemplary multi-cell structure 800. Multi-cell structure 800 is substantially similar to multi-cell structure 600 of FIG. 6. Multi-cell structure includes first, second and third cells 802, 804, 806 substantially similar to first, second and third cells 602, 604, 606, respectively. A first channel 812 on a first common sidewall 810 allows fluid communication between first and second cells 802, 804. A second channel 816 on a second common sidewall 814 allows fluid communication between second and third cells 804, 806. However, at least one sidewall 808 of first cell 802 includes a linking channel 820 spaced apart from a first channel 812. Further, at least one sidewall 808 of third cell 806 includes a linking channel 822 spaced apart from a second channel 816. Linking channels 820, 822 may be disposed on any sidewall 808 of first and second cells 802, 806 apart from first and second common sidewalls 810, 814. Further, each of first and second cells 802, 804 may include multiple linking channels 820, 822. Linking channels 820, 822 may allow fluid communication between multi-cell structure 800 and adjacent multi-cell structures (not shown). In some embodiments, linking channels allow for fluid communication between a first multi-cell structure and a second multi-cell structure and/or one or more linking cells that are not part of a multicell structure (See FIG. 8B, linking cell 860, for example).

A length of a channel (e.g. channel 812 and 816) or a linking channel (e.g. 820 and 822) may be a fraction of a total length of its corresponding sidewalls. For example, the length each of linking channels 820, 822 may be one-third of a total length of corresponding sidewall 808. In some embodiments, the linking channel length, e.g. linking channels 820, 822, may be at least 5%, at least 10%, at least 20%, at least 30%, or at least 50% of the total length of corresponding sidewall 808. In some embodiments, the linking channel length, e.g. linking channels 820, 822, may be less than 90%, less than 80% or even less than 70% of the total lengths of corresponding sidewall 808. It should be noted that depending on the selection of the first cell, second cell and third cell of the multi-cell structure, a channel of a first multi-cell structure may be a linking channel of an adjacent, second multi-cell structure and the adjacent second multi-cell structure may include one or two cells of the first multi-cell structure.

A number of channels may vary across the cells of a multi-cell structure. In some embodiments, an average number of channels (including linking channels) or cell openings of an overall cell pattern may be between 1.5 to 3 channels per cell, between 1.5 and 2.5 or even between 1.5 and 2. For the purpose of calculating the average number of channels (including linking channels) or cell openings of an overall cell pattern, a cell sidewall having multiple channels leading to the same adjacent cell is counted as a single channel. The average number of channels in the overall cell pattern may control a degree of tortuousness of a flowpath of a polishing solution. For example, a greater value of the average number of channels in the overall cell pattern may result in a lower degree of tortuousness of the flowpath. In case a cell has multiple channels, relative position between the channels may also vary. A cell may have as many channels as there are sides in a cell geometry. For example, a hexagonal cell may have anywhere between 1 to 6 channels.

FIG. 8B illustrates an exemplary pattern 850 containing two multi-cell structures. A first multi-cell structure is defined by cells 802, 804 and 806 and a second multi-cell structure is defined by cells 852, 854 and 856. An arbitrary direction is selected for fluid communication between cells and the associated axes for each channel/linking channel is drawn perpendicular to the channel length, axes A4-A9. Axes A4-A9 are substantially parallel to the working surface (e.g. working surface 402 of FIG. 4). Cell 860 is a linking cell, i.e. it is not part of a multi-cell structure, as the axes A6 and A7 associated with cells 852, 860 and 802 point in the same direction and the included angle between the axes is 180 degrees. In some embodiments, the ratio of the number of linking cells to the total number of cells of the abrasive article ranges from 0/1 to 5000/1, from 0/1 to 1000/1 from 0/1 to 500/1, from 0/1 to 200/1, from 0/1 to 100/1, from 0/1 to 50/1, from, 0/1 to 20/1, from 0/1 to 5/1, 0/1 to 1/1, from 0/1 to 0.3/1 or even from 0/1 to 0.14/1. Linking cells may facilitate the formation of the desired pattern of cells of the polishing article.

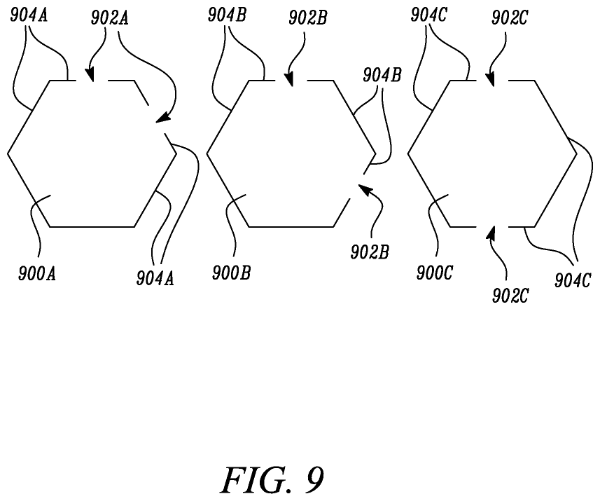

FIG. 9 illustrates various hexagonal cell configurations with two channels that can be used in a multi-cell structure. FIG. 9 shows hexagonal cells 900A, 900B and 900C. Hexagonal cell 900A includes two channels 902A in adjacent sidewalls 904A. Hexagonal cell 900B includes two channels 902B in respective sidewalls 904B that are separated by another sidewall 904B. Hexagonal cell 900C includes two channels 902C in opposing sidewalls 904C separated by two other sidewalls 904C.

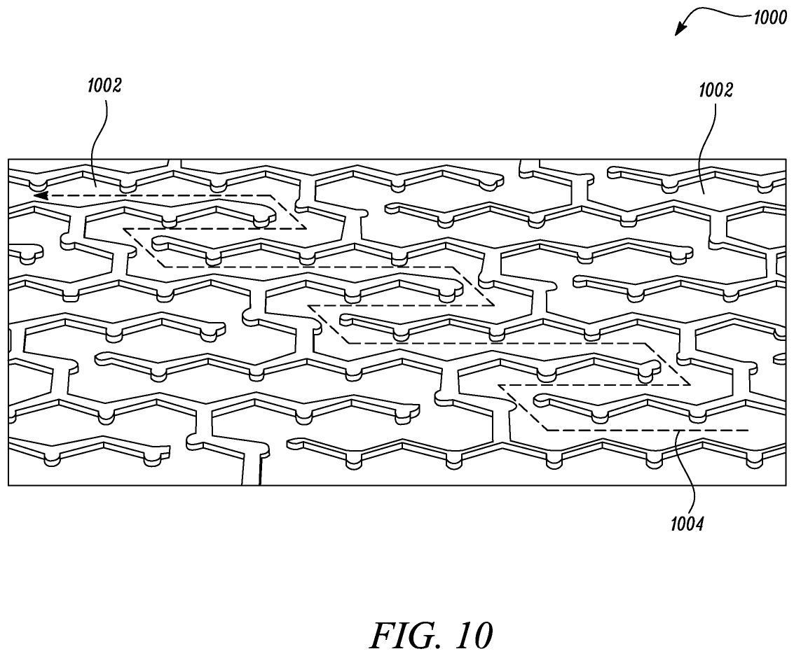

FIG. 10 illustrates an exemplary multi-cell structure 1000 arranged in a repeating pattern. Multi-cell structure 1000 may be provided on a working surface of a polishing layer of a polishing article of the present disclosure. In this embodiment, each cell 1002 of multi-cell structure 1000 is a hexagonal cell, however the shape of the cells is not limited. Cells 1002 are interconnected by channels in an angled saw tooth pattern 1004 (indicated by dashed lines). Angled saw tooth pattern 1004 may be formed by modifying and repeating multi-cell structure 600 shown in FIG. 6. During a polishing process, angled saw tooth pattern 1004 may enable a substrate (e.g., wafers) to have low stiction to the polishing article. Specifically, a fluid communication between cells 1002 may enable pressure at both above and below the substrate (in a double side polishing process, e.g. as illustrated in FIG. 2) to be substantially same and at atmospheric pressure. Interconnected cells 1002 may significantly reduce or eliminate stiction that can otherwise occur in conventional closed cell configurations with no interconnection between cells. Further, angled saw tooth pattern 1004 may provide a tortuous interconnection between cells 1002. Interconnection between cells 1002 may further allow optimal distribution of a polishing solution. Optimal distribution of the polishing solution may result in uniform polishing of the substrate. Such tortuous interconnection may also significantly impede flow of the polishing solution off the polishing article since there is no direct flowpath or channel for the polishing solution to leave the polishing article. Angled saw tooth pattern 1004 may force the polishing solution (including abrasive elements) to traverse a bearing surface of the polishing article where the polishing action occurs. This may result in optimal usage of the polishing solution, thereby enabling a high substrate removal rate.

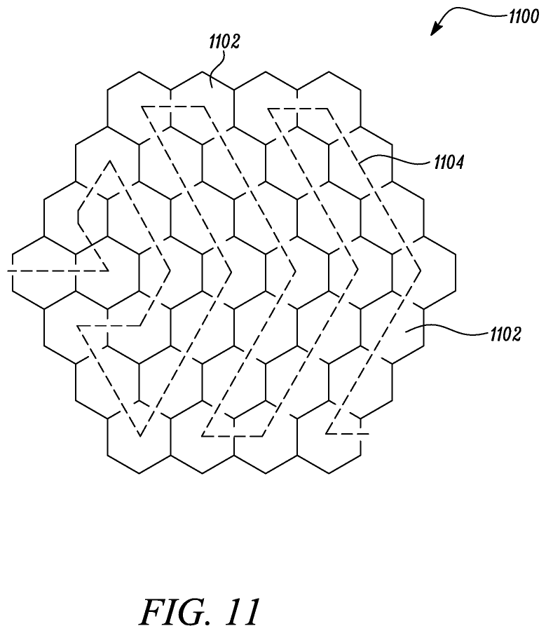

FIG. 11 illustrates an exemplary cell pattern 1100 that includes a plurality of multi-cell structures arranged in a repeating pattern. Cell pattern 1100 may be provided on a working surface of a polishing layer of a polishing article of the present disclosure. In this embodiment, each cell 1102 of cell pattern 1100 is a hexagonal cell, however, the shape of the cells is not limited. Cells 1102 are interconnected by channels in a serpentine pattern 1104 (indicated by dashed lines). Serpentine pattern 1104 may be formed by modifying and repeating multi-cell structure 600 shown in FIG. 6. In this embodiment, the size of the substrate to be polished may be smaller than the cell pattern.

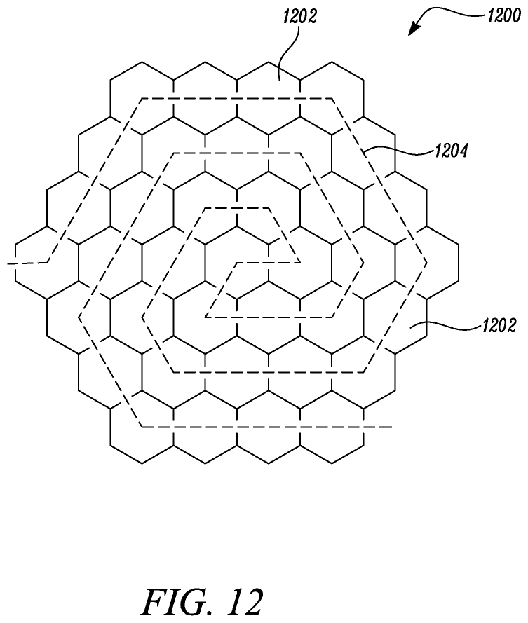

FIG. 12 illustrates an exemplary cell pattern 1200 arranged that includes a plurality of multi-cell structures arranged in a repeating pattern. Cell pattern 1200 may be provided on a working surface of a polishing layer of a polishing article of the present disclosure. In this embodiment, each cell 1202 of cell pattern 1200 is a hexagonal cell, however, the shape of the cell is not limited. Cells 1202 are interconnected by channels in a spiral pattern 1204 (indicated by dashed lines). Spiral pattern 1204 may be formed by modifying and repeating multi-cell structure 600 shown in FIG. 6. In this embodiment, the size of the substrate to be polished may be smaller than the cell pattern.

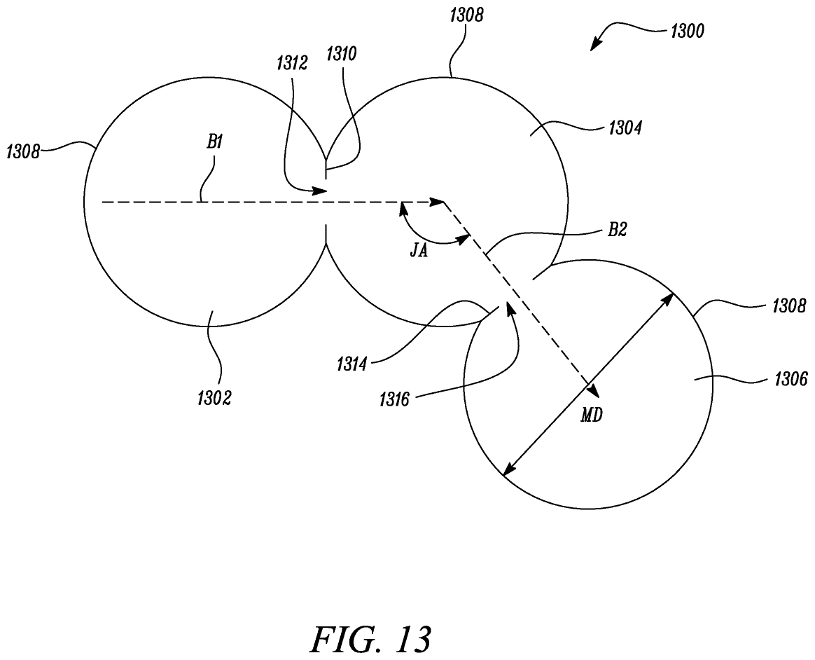

FIG. 13 illustrates an exemplary multi-cell structure 1300. A working surface of a polishing layer of a polishing article (e.g., polishing article 400 of FIG. 4) may include at least one multi-cell structure 1300. Multi-cell structure 1300 includes three cells, defined as a first cell 1302, a second cell 1304, and a third cell 1306. Each of three cells 1302, 1304, 1306 includes one sidewall 1308 defining a cell shape. The cell shape may act as a reservoir for a polishing solution, such as polishing solution 130 shown in FIG. 1. The reservoir may increase a solution dwell time on a polishing article during polishing. In the illustrated embodiment, each of cells 1302, 1304, 1306 has a circular cell shape. Therefore, each of cells 1302, 1304, 1306 includes one sidewall 1308.

First cell 1302 and second cell 1304 include a first common sidewall region 1310 which is formed by the intersection of sidewalls 1308 of first and second cells 1302, 1304. First common sidewall region1310 includes a first channel 1312. First channel 1312 has a first channel length. First channel 1312 allows fluid communication between first cell 1302 and second cell 1304. First channel 1312 further includes a first axis B1 perpendicular to first channel length and substantially parallel to the working surface. Further, second cell 1304 and third cell 1306 includes a second common sidewall region 1314 which is formed by the intersection of sidewalls 1308 of second and third cells 1304, 1306. Second common sidewall 1314 includes a second channel 1316. Second channel 1316 has a second channel length. Second channel 1316 allows fluid communication between second cell 1304 and third cell 1306. Second channel 1316 further includes a second axis B2 perpendicular to second channel length and substantially parallel to the working surface. An included angle JA between first axis B1 and second axis B2 is from 0° and less than 180°. In some embodiments, included angle JA is greater than 20° and no greater than 160°. In some embodiments, included angle JA is greater than 45° and no greater than 135°.

Each of cells 1302, 1304, 1306 has a longest dimension MD based on the cell shape. In case of the circular cell shape, longest dimension MD is a diameter of each cell 1302, 1304, 1306. In some embodiments, longest dimension MD of a cell may be between 10 microns and 10 cm, between 100 microns and 5 cm or even between 500 microns and 1 cm. The longest dimension MD of the three cells of a multi-cell structure may be the same for all three cells or may be different, depending on each individual cell size and shape.

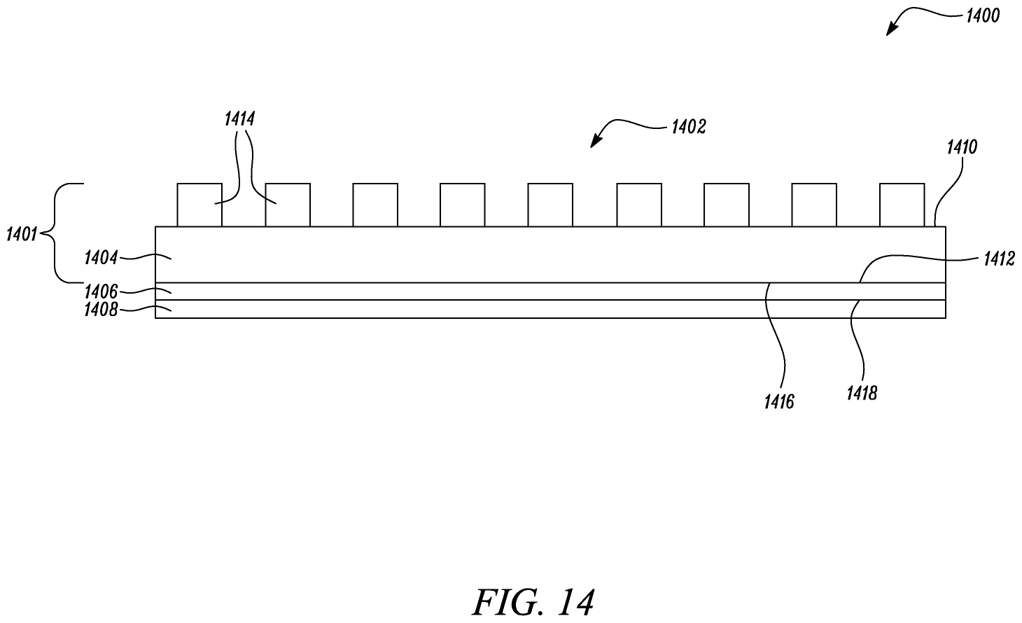

FIG. 14 illustrates a schematic cross-sectional diagram of an exemplary polishing article 1400. Polishing article 1400 includes polishing layer 1401. Polishing layer 1401 includes at least one multi-cell structure 1402 and a backing 1404. Backing 1404 includes a first surface 1410 and an opposed second major surface 1412. In some embodiments, at least one multi-cell structure 1402 may be similar to multi-cell structure 600 of FIG. 6 and may include three cells. At least one sidewall 1414 of each of the three cells of at least one multi-cell structure 1402 is in contact with first major surface 1410 of backing 1404. In some embodiments, backing 1404 and at least one multi-cell structure 1402 are a unitary body. In alternative embodiments, backing 1404 and at least one multi-cell structure 1402 may be separate components that are joined to each other.

Polishing article 1400 may also include an adhesive 1406 and a release liner 1408. Adhesive 1406 has opposed first and second major surfaces 1416, 1418. First major surface 1416 of adhesive 1406 is disposed on second major surface 1412 of backing 1404. Release liner 1408 is disposed on second major surface 1418 of adhesive 1406. During use, the release liner is typically removed from adhesive 1406. Polishing article 1400 may then be attached to a platen of a polishing tool via adhesive 1406.

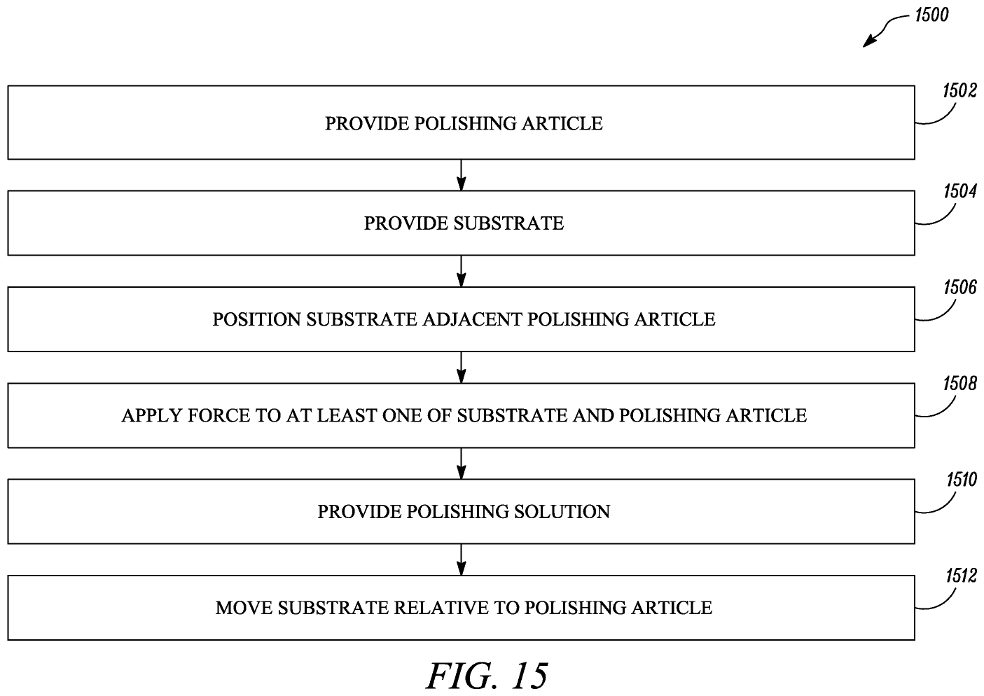

The present disclosure further relates to a method of polishing substrates. FIG. 15 is a flow diagram of an exemplary method 1500 of polishing a substrate in accordance with some embodiments discussed herein. Method 1500 may be carried out using a polishing system, such as polishing system 100A and 100B described with respect to FIGS. 1 and 2, respectively, or with any other polishing system, e.g., single or double-sided polishing and lapping systems.

Referring to FIGS. 1 and 15, in some embodiments, method 1500 of polishing a substrate may include providing (1502) a polishing article, such as polishing article 140. Method 1500 may further includes providing (1504) a substrate, such as substrate 120, having a surface to be polished. The method may further include positioning (1506) the substrate adjacent the polishing article. The surface to be polished of the substrate is adjacent to at least one multi-cell structure (e.g., multi-cell structure 600) of the polishing article. The method may further include applying (1508) a force to at least one of the substrate and the polishing article, such that a pressure is applied to the substrate surface to be polished and the at least one multi-cell structure of the polishing article. Method 1500 may further include providing (1510) a polishing solution between the surface to be polished of the substrate and the at least one multi-cell structure of the polishing article. The polishing solution may be provided to the polishing article prior to applying force to at least one of the substrate and polishing article. Method 1500 may further include moving (1512) the substrate relative to the polishing article. For example, referring to FIG. 1, polishing head assembly 116A may apply force to substrate 120 against polishing surface 118 of polishing article 140 (which may be coupled to platen 112A) in the presence of polishing solution 130 as platen 112A is moved (e.g., translated and/or rotated) relative to polishing head assembly 116A. Additionally, polishing head assembly 116A may be moved (e.g., translated and/or rotated) relative to platen 112A. As a result of the force and relative motion, the abrasive particles (which may be contained in/on polishing article 140 and/or polishing solution 130) may remove material from the surface of substrate 120.

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

In a first embodiment the present disclosure provides a polishing article comprising: a polishing layer having a working surface including at least one multi-cell structure disposed on the working surface, wherein the at least one multi-cell structure includes three cells, defined as a first cell, a second cell and a third cell, wherein each of the three cells includes at least one sidewall defining a cell shape, wherein the first cell and the second cell include a first common sidewall, wherein the first common sidewall includes a first channel, having a first channel length, allowing fluid communication between the first cell and the second cell and a first axis perpendicular to the first channel length and substantially parallel to the working surface, wherein the second cell and the third cell include a second common sidewall, wherein the second common sidewall includes a second channel, having a second channel length, allowing fluid communication between the second cell and the third cell and a second axis perpendicular to the second channel length and substantially parallel to the working surface, and wherein an included angle between the first axis and the second axis is from 0° to less than 180°.

In a second embodiment, the present disclosure provides a polishing article according to the first embodiment, wherein the included angle is greater than 20° and no greater than 160°.

In a third embodiment, the present disclosure provides a polishing article according to the first embodiment or second embodiment, wherein the included angle is greater than 45° and no greater than 135°.

In a fourth embodiment, the present disclosure provides a polishing article according to any one of the first through third embodiments, wherein the at least one multi-cell structure is a plurality of multi-cell structures.

In a fifth embodiment, the present disclosure provides a polishing article according to the fourth embodiment, wherein the plurality of multi-cell structures has a cell density from 0.01 cells per square centimeter to 1000000 cells per square centimeter.

In a sixth embodiment, the present disclosure provides a polishing article according to the fourth embodiment, wherein the plurality of multi-cell structures has a cell density from 1 cell per square centimeter to 100 cells per square centimeter.

In a seventh embodiment, the present disclosure provides a polishing article according to any one of the fourth through sixth embodiments, wherein the plurality of multi-cell structures is distributed randomly.

In an eighth embodiment, the present disclosure provides a polishing article according to any one of the fourth through sixth embodiments, wherein the plurality of multi-cell structures is distributed in a repeating pattern.

In a ninth embodiment, the present disclosure provides a polishing article according to any one of the first through eighth embodiments, wherein a longest dimension of each of the three cells is between 10 microns and 10 centimeters.

In a tenth embodiment, the present disclosure provides a polishing article according to any one of the first through eighth embodiments, wherein a longest dimension of each of the three cells is between 10 microns and 1 centimeters.

In an eleventh embodiment, the present disclosure provides a polishing article according to any one of the first through eighth embodiments, wherein a longest dimension of each of the three cells is between 10 microns and 1000 microns.

In a twelfth embodiment, the present disclosure provides a polishing article according to any one of the first through eleventh embodiments, wherein the polishing layer is a unitary body.

In a thirteenth embodiment, the present disclosure provides a polishing article according to any one of the first through twelfth embodiments, wherein the polishing layer further comprises a backing having a first major surface and an opposed second major surface, wherein the at least one multi-cell structure is disposed on the first major surface of the backing, and wherein the at least one sidewall of each of the three cells of the at least one multi-cell structure is in contact with the first major surface of the backing.

In a fourteenth embodiment, the present disclosure provides a polishing article according to the thirteenth embodiment further comprising an adhesive having opposed first and second major surfaces, wherein the first major surface of the adhesive is disposed on the second major surface of the backing.

In a fifteenth embodiment, the present disclosure provides a polishing article according to the fourteenth embodiment further comprising a release liner disposed on the second major surface of the adhesive.

In a sixteenth embodiment, the present disclosure provides a polishing article according to any one of the first through fifteenth embodiments, wherein the at least one sidewall of the first cell includes a linking channel spaced apart from the first channel.

In a seventeenth embodiment, the present disclosure provides a polishing article according to any one of the first through sixteenth embodiments, wherein the at least one sidewall of the third cell includes a linking channel spaced apart from the second channel.

In an eighteenth embodiment the present disclosure provides a polishing system comprising: the polishing article according to any one of the first through seventeenth embodiments; and a polishing solution disposed on the at least one multi-cell structure of the polishing article.

In a nineteenth embodiment the present disclosure provides a method of polishing a substrate comprising:
providing a polishing article according to any one of the first through seventeenth embodiments;
providing a substrate having a surface to be polished;
position the substrate adjacent the polishing article, wherein the surface to be polished of the substrate is adjacent the at least one multi-cell structure of the polishing article;
applying a force to at least one of the substrate and the polishing article, such that a pressure is applied to the substrate surface to be polished and the at least one multi-cell structure of the polishing article; and
moving at least one of the substrate and polishing article relative to each other.

In a twentieth embodiment, the present disclosure provides a method of polishing according to the nineteenth embodiment further comprising providing a polishing solution between the surface to be polished of the substrate and the at least one multi-cell structure of the polishing article.

### EXAMPLES

### Preparation Procedures and Test Methods

### Preparation of Abrasive Slurry 1

Abrasive slurry in the present invention is composed of 1% by wt. diamond composite 1 (DC1) and 99% by wt. triethylene glycol (available from Brenntag Great Lakes). The abrasive slurry was prepared by adding DC1 into triethylene glycol in the aforementioned proportions.

DC1 was prepared from an aqueous dispersion, using a spray drying technique, as follows: 49 g of Standex 230 (available from A.E. Staley, Decatur Ill.) was added to 1,350 g of deionized water and stirred continuously. After 5 minutes, 4 grams of Aerosol AY (available from Cytec Industries, Woodland Park N.J.), diluted 1:1 by wt. with methyl ethyl ketone, and 800 g of MB-M1 #0.15 diamond powder (available from Worldwide Superabrasives, Boynton Beach Fla.) was then added to the solution with continual mixing and stirred for 5 minutes. The diamond slurry was ultrasonically mixed for 2 hours. 800 g of milled SP1086 glass (available from Specialty Glass, Wilmington Del.), was added to the solution over a 1 minute time interval and stirred for 5 minutes. The slurry was homogenized for 10 minute at 10,000 RPMs. Note that the glass was milled to a particle size of about 3.8 microns, prior to use. The dispersion was then atomized in a centrifugal atomizer, a Mobile Miner 2000 (from GEA Process Engineering A/S, Soborg, Denmark). The atomization was completed using a co-current nozzle run at 2 bar. Air was supplied at 200° C. into the atomization chamber and was used to dry the droplets as they formed, producing spray dried abrasive composites. The collected composites were then combined with AlOx (available from Fujimi, Elmhurst Ill.), forming a 63/37 composite/AlOx (wt./wt.) powder blend. The powder blend was vitrified at 650° C. for 1 hr. After cooling, the vitrified, ceramic abrasive composites were passed through a conventional sieve having openings of about 38 microns. The collected vitrified, ceramic abrasive composites were designated as DC1.

### Polishing Test Method

Polishing was conducted using a Speedfam Model 9B-5 polisher (available from Speedfam USA, Buffalo Grove, Ill.). Annular shaped polishing articles having a 24.9 inch (63.2 cm) outer diameter and a 9.4 inch (23.9 cm) inner diameter were mounted on the top and bottom platens of the polisher. The substrate to be polished was silicon carbide wafers. Three 100 mm diameter 4H n-type silicon carbide wafers (available from Anhui Greestals Bio-Technology Co., Anhui, China), one per carrier, was placed in the polisher. The carriers and wafers were evenly distributed around the platen for optimal stability. For the test, the bottom platen was rotated at 50 rpm, with the top platen at 17 rpm. Polishing time was 60 minutes. A downforce of 52 kg was applied to achieve polishing pressure of 3 psi. The previously described Abrasive Slurry 1 was applied to the polishing articles at a flow rate of 2.5 g/min.

### Stiction Test Method

Stiction was determined qualitatively on a 1 to 4 scale, with 1 being lowest and 4 being the highest stiction level. After each 60 min run, the carriers were removed and each wafer was moved to the outer edge of the pad and removed by sliding off of the pad.

The level of difficulty in sliding each wafer to the outer edge of the pad, herein defined as stiction, was graded from 1 to 4, 1 being the easiest to slide off and 4 being the most difficult to slide off.

### Removal Rate Test Method

Removal rate was calculated as the change in wafer thickness divided by the polishing time. Wafer thickness, after 60 mins of polishing time, was measured at about the same spot on each wafer after each polish run. It was measured using a Mitutoyo 293-330 micrometer (available from Grainger, Plymouth Minn.). For a given trial, the removal rate is taken as the average of the individual removal rate of each wafer.

### Example 1

The polishing article of Example 1 was prepared as follows. A Computer Aided Design (CAD) model was generated having the desired cell structure and pattern, see FIG. 10. The cells were hexagonally shaped having a longest dimension of about 5.4 mm and a sidewall height of about 300 microns. The sidewalls had a taper of about 106 degrees. The channels of the cells were about 1.2 mm in length at the top of the cell wall (distal end) and about 0.9 mm length at the base of the sidewall. For the CAD model, the pattern of FIG. 10 is repeated to produce a cell structure disposed over an area of 33.3 cm×33.3 cm, which included a plurality of multi-cell structures. The plurality of multi cell structures along with their corresponding channels produced an angled saw tooth pattern for fluid flow, see FIG. 10. The CAD model was downloaded to a 3D printer, model Objet Eden500V, available from Stratasys Ltd., Eden Prairie, Minn. Using the 3D printer with Rigur RD450, available from Stratasys Ltd., as the material, the pattern of the CAD model was printed, producing a polishing layer of the polishing article. The process was repeated seven additional time, yielding seven additional polishing articles.

A sub pad assembly was necessary to make the polishing article of Example 1. The sub pad assembly was made by laminating 300LSE double coated tape (available from 3M) to a 0.76 mm thick polycarbonate sheet (available from Sabic) on one side, and 442 KW double coated tape (available from 3M) on the opposite side. The entire sub pad assembly had dimensions of 120 cm×120 cm.

In order to form a polishing article of larger dimensions, four patterned top layer pieces were tiled together and laminated onto the 300LSE side of the sub pad assembly, yielding a polishing article having dimensions of about 66 cm×66 cm. This article was then laser cut into annular shape having a 24.9 inch (63.2 cm) outside diameter and a center hole having 9.4 inch (23.9 cm) diameter, yielding Example 1.

### Comparative Example 2 (CE-2)

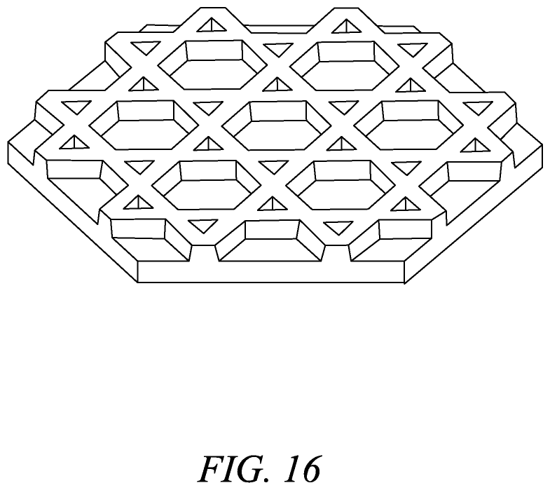

The polishing article of Comparative Example 2 was prepared similarly to that of Example 1, except the following modifications were made. A CAD model was generated that had cells that did not include channels, see the cell pattern of FIG. 16. The cells were hexagonal shaped having a longest dimension of about 4.9 mm and a sidewall height of about 800 microns. The sidewalls had a taper of about 106 degrees.

Using the Polishing Test Method described above, five polishing trials were run with the polishing articles of Example 1 and four trials were run with the polishing article of Comparative Example 2. After each trial, the stiction and removal rate were monitored for each of the three wafers of a trial, using the Stiction Test Method and Removal Rate Test Method. Results are shown in Tables 1 and 2, respectively.

TABLE 1
Stiction Data for Example 1 and Comparative Example 2

| | Example 1 | CE-2 |
|---|---|---|
| Trial 1 | 1 | 1 |
| | 2 | 4 |
| | 1 | 2 |
| Trial 2 | 2 | 2 |
| | 1 | 3 |
| | 1 | 4 |
| Trial 3 | 1 | 3 |
| | 1 | 3 |
| | 2 | 3 |
| Trial 3 | 2 | 4 |
| | 1 | 1 |
| | 1 | 4 |
| Trial 4 | 1 | — |
| | 1 | — |
| | 2 | — |
| Average | 1.3 | 2.8 |
| Standard Deviation | 0.49 | 1.1 |

TABLE 2
Removal Rate Data for Example 1 and Comparative Example 2.

| Trial | Example 1 (micron/min) | CE-2 (micron/min) |
|---|---|---|
| 1 | 0.14 | 0.18 |
| 2 | 0.16 | 0.17 |
| 3 | 0.17 | 0.17 |
| 4 | 0.17 | 0.17 |
| 5 | 0.16 | — |
| Average | 0.16 | 0.17 |
| Standard Deviation | 0.012 | 0.005 |

The results shown in Table 1 indicate that the stiction of Example 1 was improved (lower value) compared to the stiction of Comparative Example 2. The results of Table 2 indicate that the removal rates of Example 1 and Comparative Example 2 were similar.

Various embodiments of the invention have been described. These and other embodiments are within the scope of the following claims.

1. A polishing article comprising a polishing layer having a working surface including at least one multi-cell structure disposed on the working surface, wherein the at least one multi-cell structure includes three cells, defined as a first cell, a second cell and a third cell, wherein each of the three cells includes at least one sidewall defining a cell shape, wherein the first cell and the second cell include a first common sidewall, wherein the first common sidewall includes a first channel, having a first channel length, allowing fluid communication between the first cell and the second cell and a first axis perpendicular to the first channel length and substantially parallel to the working surface, wherein the second cell and the third cell include a second common sidewall, wherein the second common sidewall includes a second channel, having a second channel length, allowing fluid communication between the second cell and the third cell and a second axis perpendicular to the second channel length and substantially parallel to the working surface, and wherein an included angle between the first axis and the second axis is from 0° to less than 180°.

2. The polishing article of claim 1, wherein the included angle is greater than 20° and no greater than 160°.

3. The polishing article of claim 1, wherein the included angle is greater than 45° and no greater than 135°.

4. The polishing article of claim 1, wherein the at least one multi-cell structure is a plurality of multi-cell structures.

5. The polishing article of claim 4, wherein the plurality of multi-cell structures has a cell density from 0.01 cells per square centimeter to 1000000 cells per square centimeter.

6. The polishing article of claim 4, wherein the plurality of multi-cell structures has a cell density from 1 cell per square centimeter to 100 cells per square centimeter.

7. The polishing article of claim 4, wherein the plurality of multi-cell structures is distributed randomly.

8. The polishing article of claim 4, wherein the plurality of multi-cell structures is distributed in a repeating pattern.

9. The polishing article of claim 1, wherein a longest dimension of each of the three cells is between 10 microns and 10 centimeters.

10. The polishing article of claim 1, wherein a longest dimension of each of the three cells is between 10 microns and 1 centimeters.

11. The polishing article of claim 1, wherein a longest dimension of each of the three cells is between 10 microns and 1000 microns.

12. The polishing article of claim 1, wherein the polishing layer is a unitary body.

13. The polishing article of claim 1, wherein the polishing layer further comprises a backing having a first major surface and an opposed second major surface, wherein the at least one multi-cell structure is disposed on the first major surface of the backing, and wherein the at least one sidewall of each of the three cells of the at least one multi-cell structure is in contact with the first major surface of the backing.

14. The polishing article of claim 13, further comprising an adhesive having opposed first and second major surfaces, wherein the first major surface of the adhesive is disposed on the second major surface of the backing.

15. The polishing article of claim 14, further comprising a release liner disposed on the second major surface of the adhesive.

16. The polishing article of claim 1, wherein the at least one sidewall of the first cell includes a linking channel spaced apart from the first channel.

17. The polishing article of claim 1, wherein the at least one sidewall of the third cell includes a linking channel spaced apart from the second channel.

18. A polishing system comprising:
the polishing article according to claim 1; and
a polishing solution disposed on the at least one multi-cell structure of the polishing article.

19. A method of polishing a substrate comprising:
providing a polishing article according to claim 1;
providing a substrate having a surface to be polished;
position the substrate adjacent the polishing article, wherein the surface to be polished of the substrate is adjacent the at least one multi-cell structure of the polishing article;
applying a force to at least one of the substrate and the polishing article, such that a pressure is applied to the substrate surface to be polished and the at least one multi-cell structure of the polishing article; and
moving at least one of the substrate and polishing article relative to each other.

20. The method of polishing according to claim 19 further comprising providing a polishing solution between the surface to be polished of the substrate and the at least one multi-cell structure of the polishing article.
